(19) United States
(12) Patent Application Publication
(10) Pub. No.: US 2025/0265502 A1
(43) Pub. Date: Aug. 21, 2025

(54) Validation Software

(71) Applicant: Neeraj Bhavani, Aliso Viejo, CA (US)

(72) Inventor: Neeraj Bhavani, Aliso Viejo, CA (US)

(21) Appl. No.: 19/057,893

(22) Filed: Feb. 19, 2025

Related U.S. Application Data
(60) Provisional application No. 63/555,397, filed on Feb. 19, 2024.

(51) Int. Cl. G06N 20/00

(52) U.S. Cl. CPC G06N 20/00

(57) ABSTRACT

A method of using an artificial intelligence learning system (AI) to provide a new protocol for a target technology is disclosed. The AI learning system receives functional and contextual characteristics of the target technology from a user and identifies relevant choices that were made in other technologies. The AI learning system receives a selection of at least one of the current choices from the user, communicates with the user as to why the section was made, and improves the accuracy of future choices of technologies. The AI learning system also obtains a previously created protocol for the user's selection, and a publicly available manual regarding the target technology, to populate and validate at least one new protocol for the target technology. The user then acquires and installs a new piece of equipment for performing the new protocol.

### FIELD OF THE INVENTION

The field of the invention is process validation.

### BACKGROUND

The following description includes information that may be useful in understanding the present invention. It is not an admission that any of the information provided herein is prior art or relevant to the presently claimed invention, or that any publication specifically or implicitly referenced is prior art.

Process validation is the process of assuring that manufacturing processes can consistently output products that meet predetermined specifications, despite the presence of variable process inputs. Process validation involves collecting and analyzing data from the design stage throughout commercial production to determine the reliability of manufacturing processes. Various government agencies, such as the US Food and Drug Administration (FDA), have published guidelines and best practices for process validation.

FIG. 1 shows the current state of user workflow for handling process validations. The workflow is highly dependent upon manual efforts, with individual workers (whether employees or consultants) focused on individual projects. Training time is high, and loss of experienced validation workers often results in loss of their institutional knowledge. Even for experienced validation workers, increased complexity of protocol requirements, intricacies of equipment use, changing regulations, human error, and data integrity issues all conspire to render the current user workflow increasingly unworkable.

One particular problem is protocol completeness. For example, an engineer looking to install an oven at a work site is faced with a maze of questions that have difficult-to-find answers. Information may not be stored in one place, and may even be stored in different formats across different systems (URS, FAT, Equipment manuals, Regulatory requirements, etc.). Critical information is often only known by domain experts, who may not have documented the information in written form. Even if the information is documented, it is often not indexed or easily accessible. The outcome is that manual searching and retrieving information increases the likelihood of human errors and the risk of non-compliance.

Another problem is credibility. With inaccurate protocol documentation to begin with, the results too become questionable. The verification employee typically has little to no insight from past installations, and no access to lessons learned. When a protocol is executed, incorrect detail in acceptance criteria or failure to comply with regulations can result in qualification “failure”, which results in rework results, budget overruns, and job dissatisfaction

Lack of risk predictability is yet a third problem. In the current state, systems are unable to process structured and unstructured data to assist engineers with decision making. Accordingly, the engineers cannot proactively prevent errors or non-compliance to regulations, which increases the risk of non-compliance when regulations are updated, and potentially increases risk to patient and customer safety.

What is needed are systems and methods that leverage artificial intelligence to improve validation protocols by streamlining access to institutional knowledge and intelligently interpreting big data.

### SUMMARY OF THE INVENTION

The inventive subject matter provides apparatus, systems, and methods in which an artificial intelligence learning system (AI) is leveraged to provide a validated protocol for a target technology.

In a preferred method, the AI (a) receives from a human user, functional and contextual characteristics of the target technology, and based upon the functional and contextual characteristics, (b) identifies to the human user current choices of other technologies deemed to have high relevance to the functional and contextual characteristics; (c) receives from the human user a selection of at least one of the other technologies; (d) obtains at least a portion of a previously created protocol for the selection; and uses that previously created protocol as a template to create a new protocol for the target technology.

The target technology can be any technology for which government regulations apply, including for example, chemicals and pharmaceuticals, medical devices, non-medical-related mechanical and electronic devices.

To improve the selections over time, the AI preferably communicates with the human user, asking why the section was made. Such communication are preferably done in natural language, and preferably using a Software as a Service (Saas) application.

Creation of the new protocol can be additionally based on one or more publicly available manufacturer's or other manuals, and optionally other information regarding the target technology that the AI system has access to from a local computer of the user or others, including co-workers of the user.

In another contemplated step, the AI can validate elements of the new protocol against a current regulatory standard.

Contemplated methods can create any one or more of installation qualification (IQ) protocol, an operations qualification (OQ) protocol, and performance qualification (PQ) protocol. Created protocols can be in any language, which can be different from a language of the template protocol.

In yet other embodiments, the AI can apply a history of regulatory changes to provide a non-conformance risk assessment for the at least one new protocol.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

FIG. 1 is a diagram of a prior art validation workflow.

FIG. 2 is a diagram of a new validation workflow.

FIG. 3 is flowchart of an implementation process.

FIG. 4 is flowchart of a validation process.

### DETAILED DESCRIPTION

Throughout this application, references to AI are to be interpreted broadly, to include execute of machine learning softer on any servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

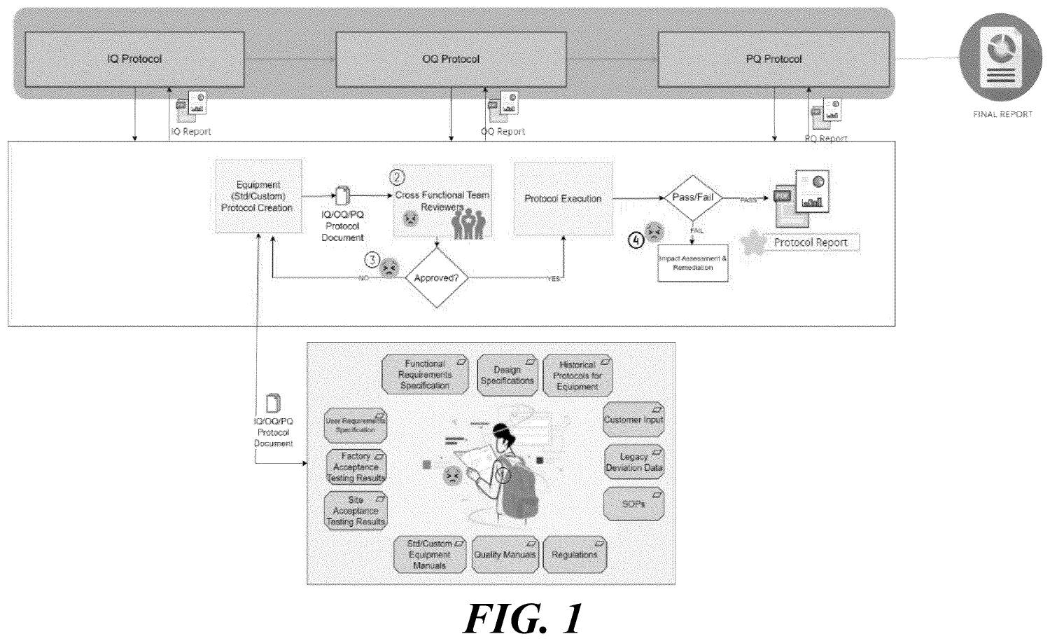

FIG. 1 depicts a prior art user workflow diagram. Individual workers, usually employees of a company, operate under a protocol to create a report with respect to a new (target) piece of equipment or other technology that the company is acquiring, or perhaps use of an existing piece of equipment or other technology that the company is moving to another location, or utilizing in a new manner. As shown in FIG. 1, there can be different workers preparing different installation qualification (IQ), operations qualification (OQ), and performance qualification (PQ) reports.

The protocol reports are typically produced using information shown in the bottom box (e.g., functional requirements, design specifications, historical protocols for equipment, customer input, legacy deviation data, SOPs, regulations, quality manuals, standard/custom equipment manuals, site acceptance testing results, factory acceptance testing results, user requirements specifications).

The reports are forwarded to other workers within the company to prepare IQ, OQ and PQ protocols, likely based upon prior experience of such other workers, and information they can glean from web searches, seminars, etc. A huge problem is that the information gained in that manner is not readily available to other workers. There can be a serious loss of institutional information when one of these workers leaves the company.

Protocol reviewers then review the prepared protocols, and either approve them for execution, or send them back for further analysis.

Reviewed protocols are then implemented, with results that the target piece of equipment or other technology being considered is either accepted or rejected. At the end of this process, there is a final protocol report.

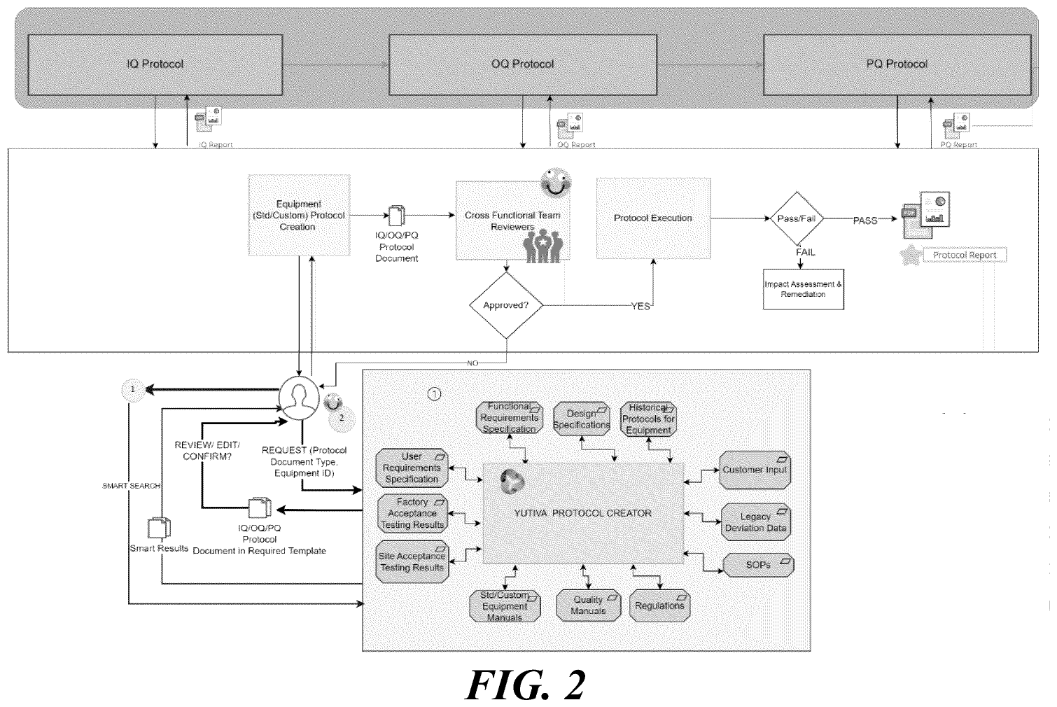

FIG. 2 shows a new workflow using aspects of the inventive subject matter. In this embodiment, known protocols are applied against the new product or brother technology, to produce IQ, OQ, and PQ reports. In the bottom box, an AI learning system (“Protocol Creator”) works with one or more human individuals to prepare protocols, as discussed further herein.

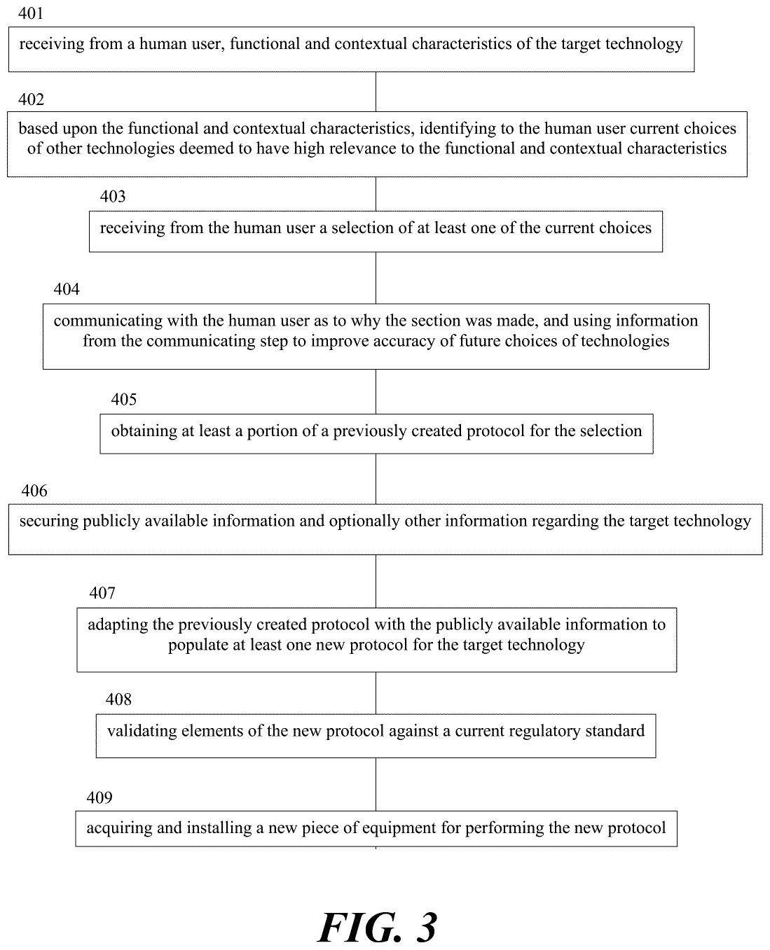

FIG. 3 shows a method of using the AI learning system in FIG. 2 to create and implement new validation protocols for a target technology.

In step 401, the AI learning system receives functional and contextual characteristics of the target technology from a human user.

In step 402, the AI learning system identifies to the user current choices of other technologies deemed to have high relevance to the functional and contextual characteristics of the target technology.

In step 403, the AI learning system receives from the user a selection of at least one of the current choices.

In step 404, the AI learning system communicates with the user as to why the section was made. The AI learning system preferably uses natural language to prompt and query the user regarding the user's reasons for making the selection. The communications from the AI learning system preferably include open-ended and non-leading questions that allow the user to provide custom and genuine responses. The AI learning system uses the user's responses to improve the accuracy and/or relevance of choices identified in step 402 for a future protocol creation.

In step 405, the AI learning system obtains at least a portion of a previously created protocol for the user's selection from step 403.

In step 406, the AI learning system secures publicly available information and optionally other information regarding the target technology.

In step 407, the AI learning system adapts the previously created protocol with the publicly available information to populate at least one new protocol for the target technology.

In step 408, the AI learning system validates elements of the new protocol against a current regulatory standard.

In step 409, the user acquires and installs a new piece of equipment for performing the new protocol.

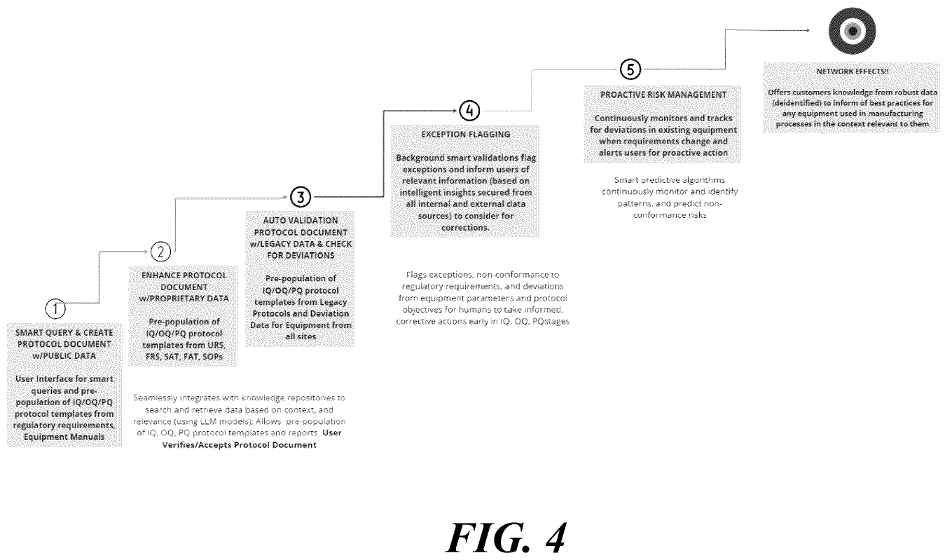

FIG. 4 shows a roadmap comprising six phases for implementing the AI learning system of FIG. 2.

In phase 1, a user interacts with the AI learning system to formulate a smart query and create a protocol document with public data. This is accomplished by pre-populating templates for a installation qualification (IQ) protocol, an operations qualification (OQ) protocol, and a performance qualification (PQ) protocol using public data, protocol templates from regulatory requirements, and equipment manuals. Identification of the public data can advantageously be accomplished using the AI learning system.

In phase 2, the AI learning system pre-populates the templates for the installation qualification (IQ) protocol, operations qualification (OQ) protocol, and performance qualification (PQ) protocol using data from URS, FRS, SAT, FAT, SOPs.

In phase 3, the AI learning system auto-validates the protocol templates and checks for deviations using current regulations, legacy data, and deviation data for equipment from different sites.

In phase 4, the AI learning system flags exceptions based on intelligent insights secured from all internal and external data sources, and informs the user(s) of such exceptions.

In phase 5, the AI learning system continuously monitors and tracks for deviations in existing equipment, based upon any updates to relevant regulations. This step can be used in proactive risk management.

In the last phase, the AI learning system culls information from many different sources within a company, including local computer sources and companywide cloud sources, and also under some circumstances calls information from multiple companies, provided the information is not proprietary to those companies. This last phase is unnumbered because it applies to each of the phases one through five. This last phase informs best practices for any equipment used in manufacturing processes in the relevant context.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention. Unless a contrary meaning is explicitly stated, all ranges are inclusive of their endpoints, and open-ended ranges are to be interpreted as bounded on the open end by commercially feasible embodiments.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of using an artificial intelligence learning system (AI) to provide a new protocol for a target technology, comprising the AI:
receiving from a human user, functional and contextual characteristics of the target technology;
based upon the functional and contextual characteristics, identifying to the human user current choices of other technologies deemed to have high relevance to the functional and contextual characteristics;
receiving from the human user a selection of at least one of the current choices;
communicating with the human user as to why the section was made, and using information from the communicating step to improve accuracy of future choices of technologies;
obtaining at least a portion of a previously created protocol for the selection;
securing a publicly available manual and optionally other information regarding the target technology;
adapting the previously created protocol with the publicly available information to populate at least one new protocol for the target technology;
validating elements of the new protocol against a current regulatory standard;
acquiring and installing a new piece of equipment for performing the new protocol.

2. The method of claim 1, further comprising accomplishing communication between the AI and the human user through a Software as a Service (Saas).

3. The method of claim 1, further comprising deriving at least some of the current choices of other technologies from a data store on a computer local to the human user.

4. The method of claim 1, further comprising deriving at least some of the current choices of other technologies from both a first data store on a first computer local to the human user, and a second data store on a second computer local to a co-worker of the human user.

5. The method of claim 1, wherein the at least one new protocol comprises an installation qualification (IQ) protocol.

6. The method of claim 1, wherein the at least one new protocol comprises an operations qualification (OQ) protocol.

7. The method of claim 1, wherein the at least one new protocol comprises a performance qualification (PQ) protocol.

8. The method of claim 1, wherein the at least one new protocol comprises an installation qualification (IQ) protocol, an operations qualification (OQ) protocol, and performance qualification (PQ) protocol.

9. The method of claim 1, further comprising translating a first language of the previously created protocol to a second different language in the at least one new protocol.

10. The method of claim 1, further comprising applying a history of regulatory changes to provide a non-conformance risk assessment for the at least one new protocol.
